(19) United States
(12) Patent Application Publication
(10) Pub. No.: US 2020/0141124 A1
(43) Pub. Date: May 7, 2020

(54) EPS EXTERIOR CLADDING PANELS AND METHOD

(71) Applicant: Nicolae Mihart, Calgary (CA)

(72) Inventor: Nicolae Mihart, Calgary (CA)

(21) Appl. No.: 16/195,771

(22) Filed: Nov. 19, 2018

(30) Foreign Application Priority Data
Nov. 6, 2018 (CA) 3,023,299

(51) Int. Cl. E04F 13/08; E04C 2/288; E04B 1/90; B32B 5/02; B32B 3/06

(52) U.S. Cl. CPC E04F 13/081; E04C 2/288; E04F 13/0885; E04B 1/90; B32B 2262/101; B32B 3/06; B32B 2307/304; B32B 2419/00; B32B 5/02

(57) ABSTRACT

An EPS insulation panel covered in reinforcing fiber glass mesh with basecoat and acrylic finish color or exterior paint. The panel can be manufacturing in different sizes or shapes and it can be glued on or installed over metal tracks with brackets on exterior building walls substrates. As designed it provides a new look and design construction application that can be easily applied to virtually any exterior wall, is easy to install and cost effective. It provides a wide range of possibilities on the matter of shape design, sizes, colors, impact resistance, thickens of insulation (depending on required R value for the project) EPS type 2 or 3 can be used.

### BACKGROUND OF THE INVENTION

This application claims benefit under 35 USC 119 to Canada National Application No. 3,023,299 filed on Nov. 6, 2018, the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of static structures of existing art and more specifically relates to module or panels having discrete edgewise or face to face connecting feature(s).

### RELATED ART

Many people in modern society live in dwellings and work in commercial buildings. There are many different finishes on these buildings. The finishes are designed to be esthetic and to protect the building from being degraded by environmental elements such as rain, sun, snow and the like. Many finishes are difficult to perform in different climates, especially when re-finishing older constructions. Further, the solutions currently available may not be cost-effective and others may provide minimal insulative qualities. A suitable solution is desired.

U.S. Pat. No. 8,458,983 to John Eugene Propst relates to a method of forming buildings, building panel structures, and building panel systems. The described method of forming buildings, building panel structures, and building panel systems includes a building panel structure, in which building panels are used to form a structure. A building panel is disclosed which includes a core and a coating applied over the core. In some embodiments the core consists of a frame and one or more than one insulating structural block. The insulating structural blocks can be encapsulated polystyrene (EPS) foam blocks. In some embodiments the coating includes an inner scratch layer and an outer main brown layer. The inner scratch layer can be formed of at least two layers. The outer main brown layer can include a fiberglass mesh embedded into the outer main brown layer. A method of forming a building panel is disclosed which includes forming a core using a frame and one or more blocks, applying an inner scratch layer to the core, and applying an outer main brown layer over the inner scratch layer.

### SUMMARY OF THE INVENTION

In view of the foregoing disadvantages inherent in the known static structures art, the present disclosure provides a novel EPS exterior cladding panel system and method. The general purpose of the present disclosure, which will be described subsequently in greater detail, is to provide an efficient and effective EPS exterior cladding panel system and method.

The invention is an EPS insulation panel covered in reinforcing fiber glass mesh with basecoat and acrylic finish color or exterior paint. The panel can be manufacturing in different sizes or shapes and it can be glued on or installed over metal tracks with brackets on exterior building walls substrates. The present invention provides a new look and design construction application that can be easily applied to virtually any exterior wall, is easy to install and cost effective. The invention provides a wide range of possibilities on the matter of shape design, sizes, colors, impact resistance, thickens of insulation (depending on required R value for the project) EPS type 2 or 3 can be used.

The panels are a light weight cladding. Using the EPS insulation panel on construction projects allows that the use of scaffolding can be effectively eliminated on most of the projects, aerial lifts may be used. The panels are premade and coated by a machine to eliminate any imperfections to the finished surface. In applications where appropriate panels may be installed over tracks with brackets. Heating and hording can be effectively eliminated from the installation process during cold season installs.

Depending on requested exterior design for the project shaped panels can be installed without aesthetic reveal to give continues surface (for example the look of hardy siding). The exterior face of the panels can be finished in a wide variety of textures and colors. As designed the system provides drainage of 10 mm for both methods of installation over metal tracks or directly glued on via adhesive. The system provide a modern architectural look with thermal and acoustic insulation and installation time is shorter than most of claddings systems. For convenience installation can be made by two or three workers crew regardless of project size. Panels can be glued on or installed over horizontal or vertical metal tracks or a mix between. Panel installation begins with tracks (10 mm Z bar with drainage holes) installation over preinstalled air/vapour barrier, flashings and insect screen on the exterior wall substrate. A U shape bracket is installed at the edge of the starting point. the first panel is inserted onto the U shaped bracket together with compatible glue see plan detail and Z bar is inserted into side grove and screw attached to the tracks, second panel is inserted into the groove of installed panel together with compatible glue, third panel will follow the same procedure and so on. The second row of panels start with a panel inserted in to the U shape bracket on the left and inserted on the tong of bottom panel together with glue following rows the same. Depending on the height and length of the wall the panels will repeat (see panels layout). At the top of the proposed wall the last row of the panels are to be closed on the top with a L shape bracket see the wall section detail. U shape, Z shape L shape brackets can be same length with the panel or same size with the Z bar tracks flange.

Panels installed over metal tracks are embedded in compatible basecoat and fiber glass mesh. For glue-on installation panels don't need basecoat and mesh on the back, need drainage channels made in to the insulation. Basecoat, glue, fiber glass mesh and exterior finish are to be compatible with the EPS board. To reduce the thickness and increase the strength of the panel depending on requirements of R value and size of panels EPS type 3 may be an option. Z bars tracks may be used to provide holes every 100 mm, 75 mm flange, 10 mm space between panels and substrate for drainage.

An EPS exterior cladding panel system is disclosed herein in a preferred embodiment comprising: at least one pre-finished panel assembly, each at least one pre-finished panel assembly including a body having a front-face comprising an exterior-finish-surface, a rear-face; and a thickness; and an insulating means (insulation); wherein the panelized EPS stucco siding system comprises a plurality of the at least one pre-finished panel assembly able to be installed in modular-functional combination. The body is defined by the front-face; the rear-face separated by the thickness, the rear-face mounted adjacent a host-building in-use. The insulating means comprises thermal-insulation and acoustic-insulation. As designed the at least one pre-finished panel assembly is able to be installed in modular combination with aesthetic reveal and alternately without aesthetic reveal to give continuous surface. The exterior-finish-surface comprises reinforced fiber glass mesh with basecoat, the basecoat also comprises acrylic finish color and alternately exterior paint. The plurality of at least one pre-finished panel assemblies may be installed in modular-functional combination via adhesive to the host-building and alternately via mountable tracks coupled to a host-building. The insulating means is integrated into the thickness of each body such that when in installed-combination the EPS exterior cladding panel system provides exterior protection for the host-building and insulation for the host-building.

A method of use/installation for the EPS exterior cladding panel system is also disclosed herein, the method comprising the steps of: providing at least one pre-finished panel assembly, each the at least one pre-finished panel assembly including a body having a front-face comprising an exterior-finish-surface; a rear-face; and a thickness; and an insulating means; and installing the EPS exterior cladding panel system which provides exterior protection for the host-building and insulation for the host-building, the insulation being thermal-insulation and acoustic-insulation. The method may comprise the step of installing which is done via adhesive and alternately mountable tracks with brackets. Other suitably equivalent fastening means may be used.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an EPS exterior cladding panel system, constructed and operative according to the teachings of the present disclosure.

FIG. 1 is a perspective view of the EPS exterior cladding panel system during an ‘in-use’ condition, showing panel installation according to an embodiment of the disclosure.

FIG. 2 is a perspective view of the EPS exterior cladding panel system of FIG. 1, according to an embodiment of the present disclosure.

FIG. 3 is a perspective view of the EPS exterior cladding panel system showing panel layout, according to an embodiment of the present disclosure.

FIG. 4 is another perspective view of the EPS exterior cladding panel system of FIG. 1, according to an embodiment of the present disclosure.

FIG. 5 is another perspective view of the EPS exterior cladding panel system of FIG. 1 showing details of panel installation, according to an embodiment of the present disclosure.

FIG. 6 is another perspective view of the EPS exterior cladding panel system of FIG. 1, showing plan detail of an inside/outside corner according to an embodiment of the present disclosure.

FIG. 6B is another perspective view of the EPS exterior cladding panel system of FIG. 1, showing plan detail of an alternate indie/outside corner according to an embodiment of the present invention.

FIG. 7 is another perspective view of the EPS exterior cladding panel system of FIG. 1, according to an embodiment of the present disclosure.

FIG. 8 is another perspective view of the EPS exterior cladding panel system of FIG. 1, showing wall section detail according to an embodiment of the present disclosure.

FIG. 9 is another perspective view of the EPS exterior cladding panel system of FIG. 1, according to an embodiment of the present disclosure.

FIG. 10 is another perspective view of the EPS exterior cladding panel system of FIG. 1, according to an embodiment of the present disclosure.

FIG. 11 is another perspective view of the EPS exterior cladding panel system of FIG. 1, showing corner detail and window/door section detail according to an embodiment of the present disclosure.

FIG. 12 is another perspective view of the EPS exterior cladding panel system of FIG. 1, showing panels as glued according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a means to cover static structures and more particularly to a EPS exterior cladding panel system as used to improve the insulation, protection and longevity of host residential and confidential buildings.

Generally, the present invention comprises EPS insulation panels covered in reinforcing fiberglass mesh with basecoat and acrylic finish color or exterior paint. The panel can be in different sizes or shapes, it can be glued on or installed over metal tracks with brackets on exterior building walls or substrates. As designed it features: 1. Unique look; 2. Low cost; and 3. Easy installation. A new look and design application can be easily applied to any exterior wall in an easy to install and cost effective way.

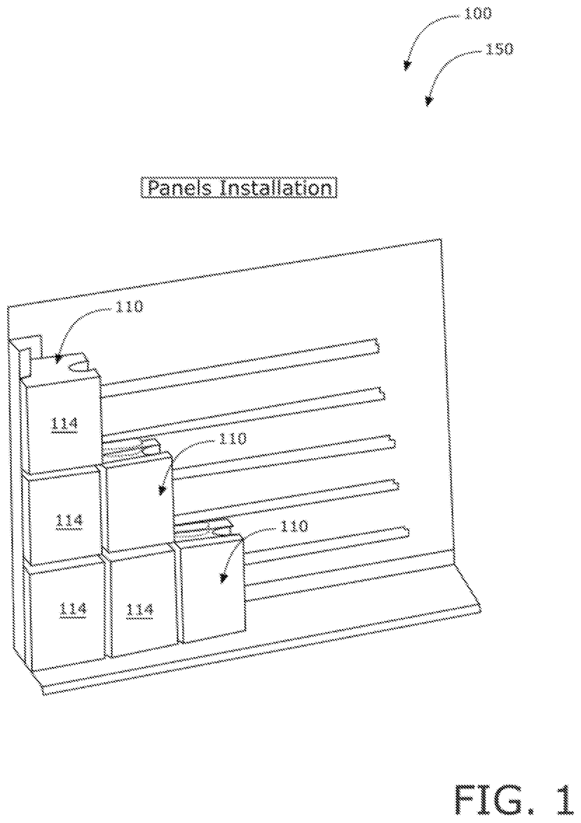

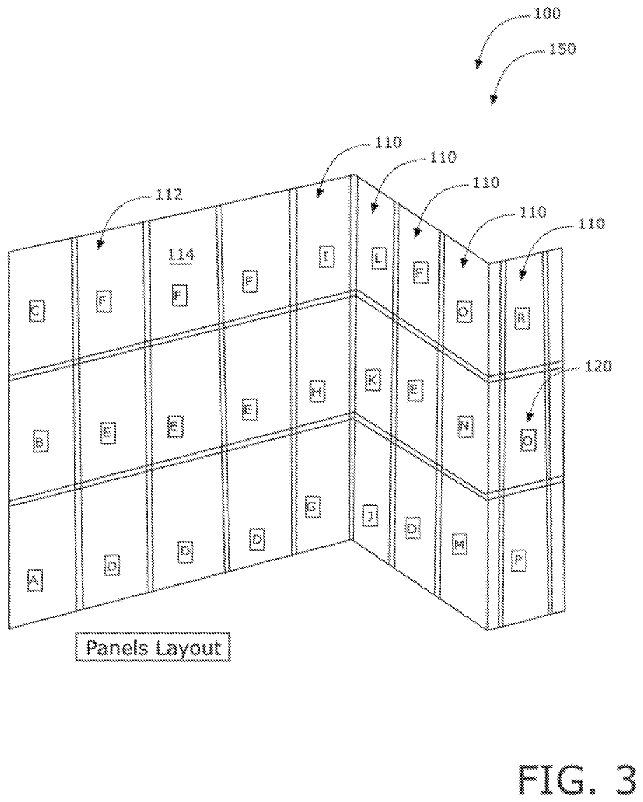

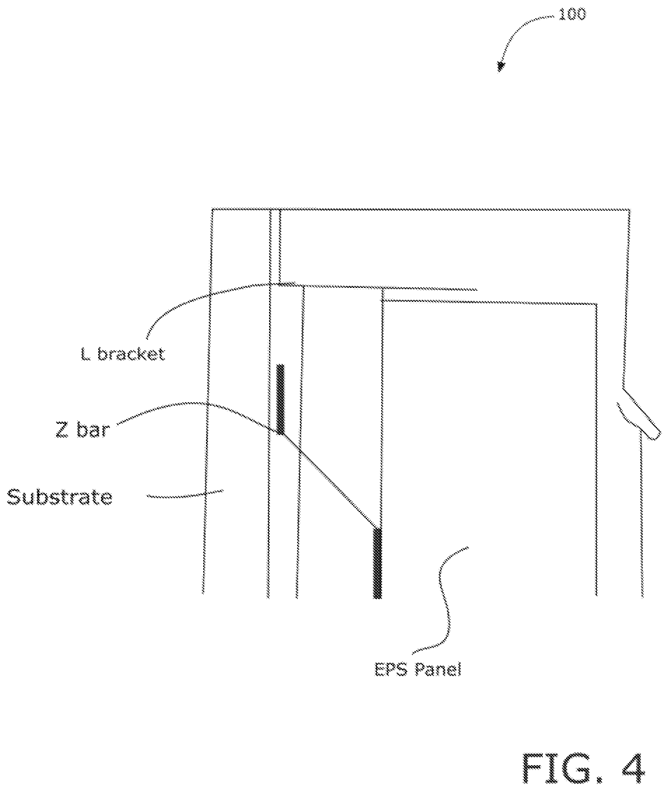

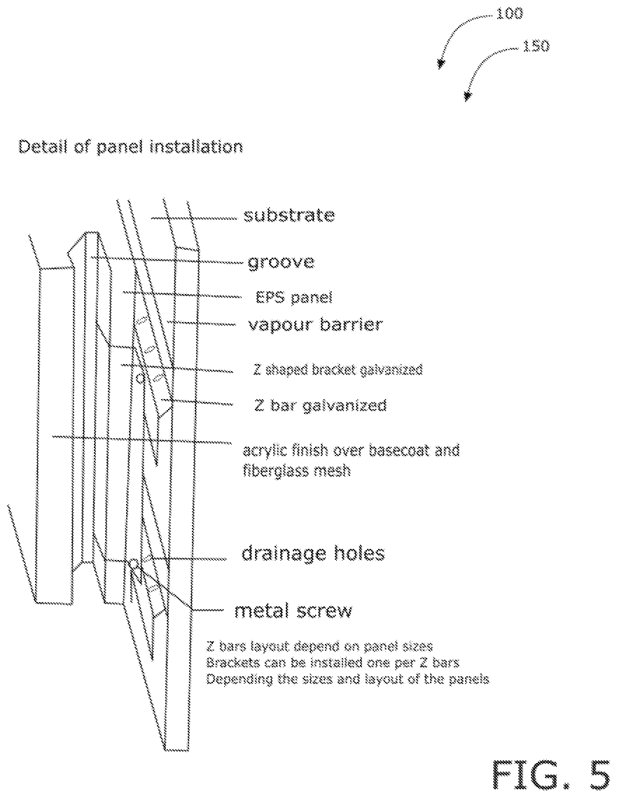

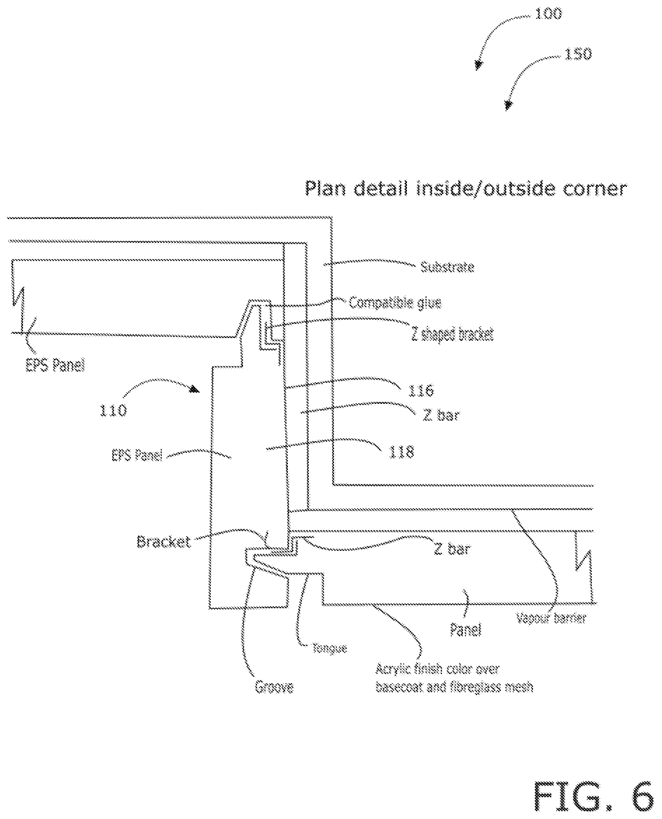

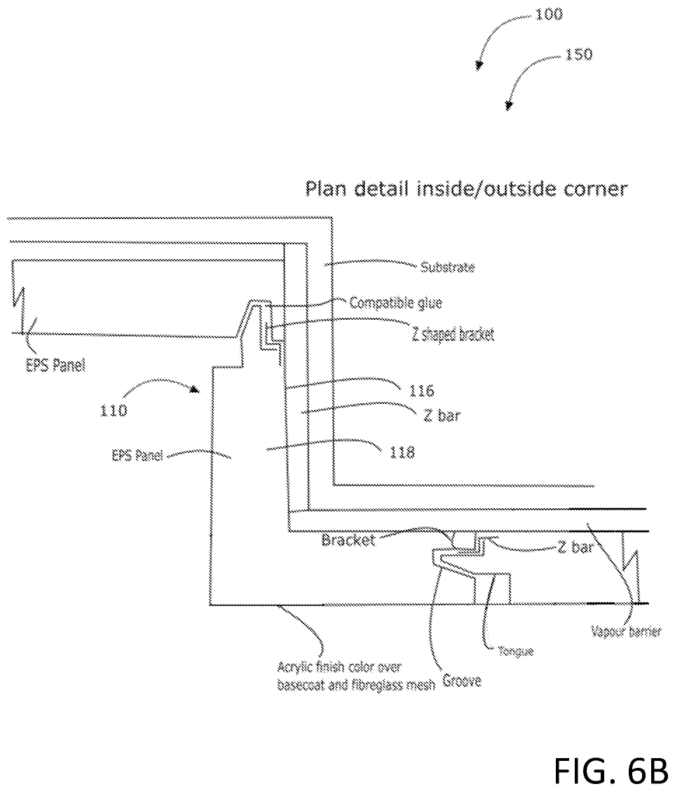

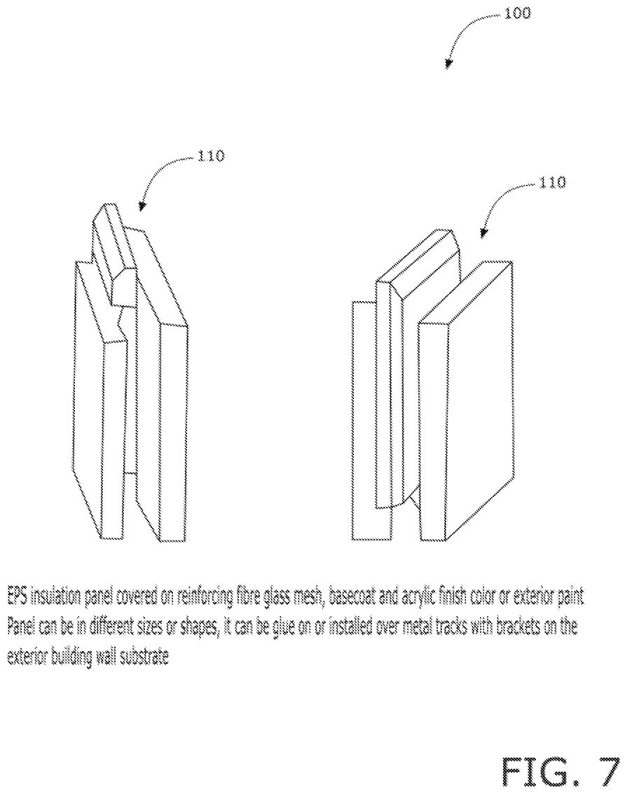

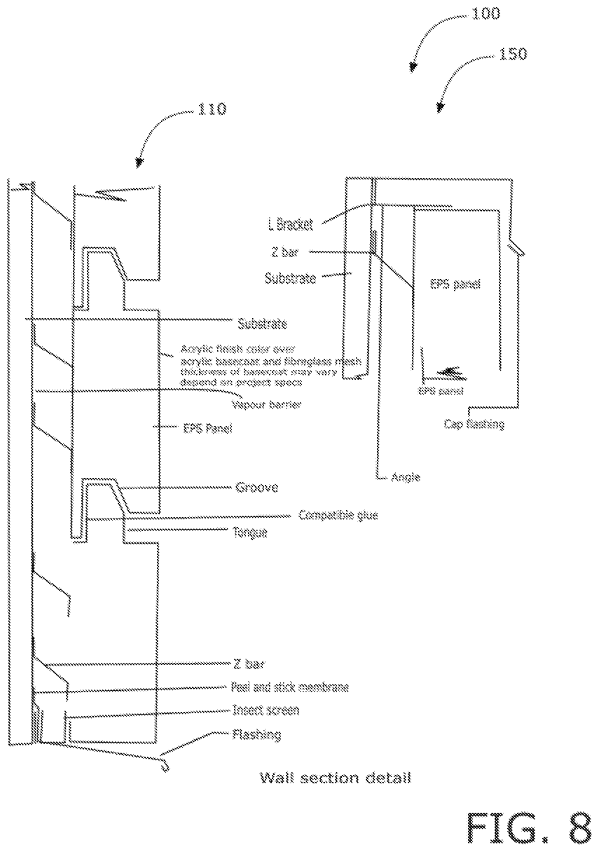

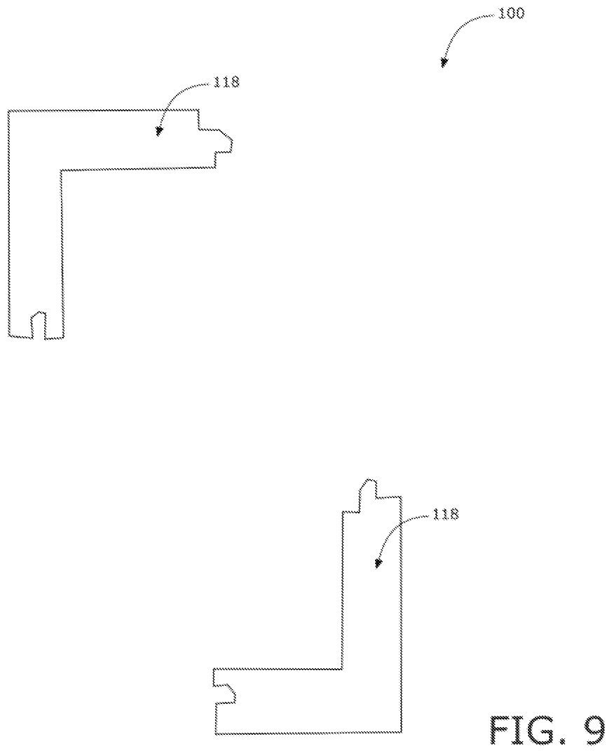

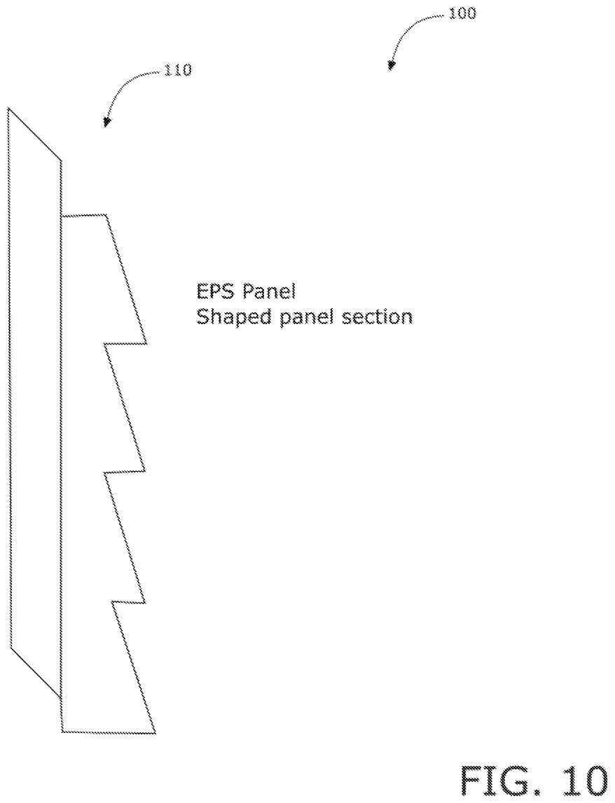

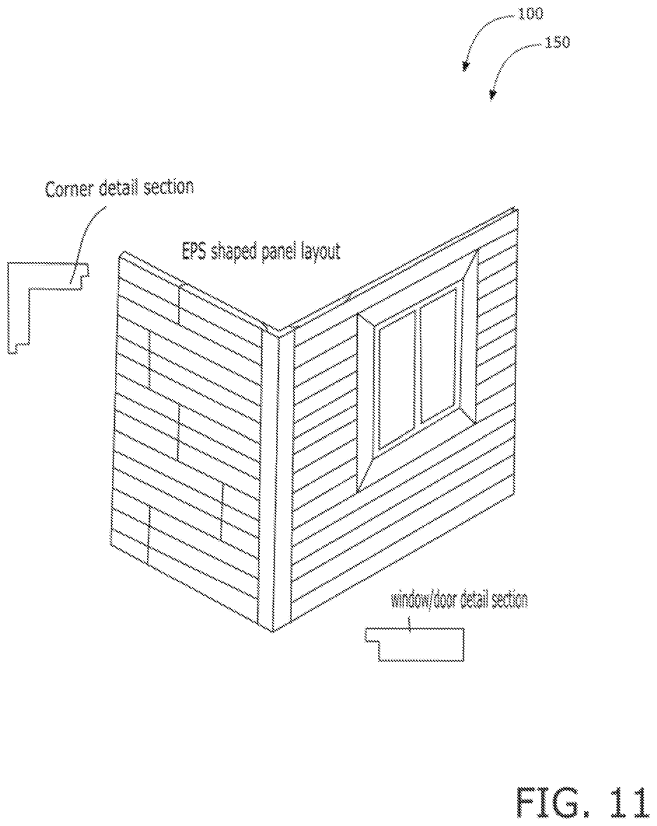

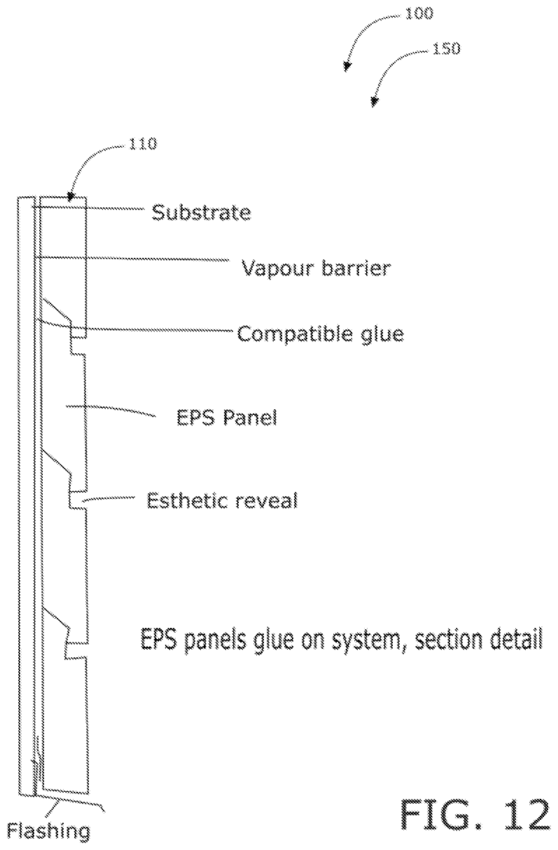

Referring now more specifically to the drawings by numerals of reference, there is shown in FIGS. 1-12, various views of an EPS exterior cladding panel system 100.

FIG. 1 shows an EPS exterior cladding panel system 100 during an ‘in-use’ condition 150, according to an embodiment of the present disclosure. Here, the EPS exterior cladding panel system 100 may be beneficial for use by a user to provide suitable protection to buildings. As illustrated, the EPS exterior cladding panel system 100 may include at least one pre-finished panel assembly 110; each at least one pre-finished panel assembly 110 including a body 112 having a front-face 114 comprising an exterior-finish-surface; a rear-face 116; and a thickness 118; and an insulating means 120. Those with ordinary skill in the art will now appreciate that upon reading this specification and by their understanding the art of insulation (thermal and acoustic) as described herein, methods of providing the insulation used therein will be understood by those knowledgeable in such art.

The panelized EPS stucco siding system 100 comprises a plurality of the at least one pre-finished panel assemblies 110 installed in modular-functional combination. The body 112 is defined by the front-face 114, and the rear-face 116 separated by the thickness 118; the rear-face 116 mounted adjacent a host-building in-use (once installed). The insulating means 120 is integrated into the thickness 118 of each body 112 such that when in installed-combination the EPS exterior cladding panel system 100 provides exterior protection for the host-building and insulation (via insulating means 120) for the host-building.

According to one embodiment, the EPS exterior cladding panel system 100 may be arranged as a kit. In particular, the EPS exterior cladding panel system 100 may further include a set of instructions. The instructions may detail functional relationships in relation to the structure of the EPS exterior cladding panel system 100 such that the EPS exterior cladding panel system 100 can be used, maintained, or the like, in a preferred manner.

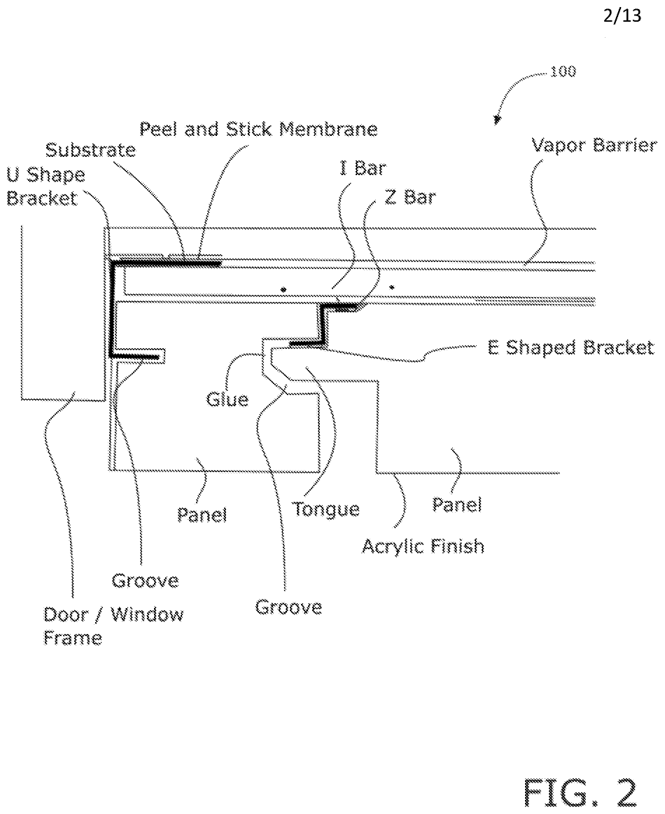

Referring now to FIGS. 2-12 showing various views of the EPS exterior cladding panel system 100 of FIG. 1, according to an embodiment of the present disclosure.

The insulating means 120 for EPS exterior cladding panel system 100 comprises thermal-insulation and acoustic-insulation. The at least one pre-finished panel assembly 110 is able to be installed in modular combination with aesthetic reveal when desired for the building finish. The at least one pre-finished panel assembly 110 is also able to be installed in modular combination without aesthetic reveal to give a continuous surface look. The exterior-finish-surface of the EPS exterior cladding panel system 100 comprises reinforced fiber glass mesh with basecoat; wherein the exterior-finish-surface comprises the reinforced fiber glass mesh with the basecoat and may also comprise acrylic finish color. The exterior-finish-surface comprising the reinforced fiber glass mesh with the basecoat may also comprise exterior paint.

The plurality of the at least one pre-finished panel assembly(ies) 110 are able to be installed in the modular-functional combination via adhesive to the host-building or via mountable tracks coupled to the host-building. The mountable tracks further comprise brackets in certain embodiments. Other fastening means may be used. The insulating means 120 comprises an R value depending on project-application. The EPS exterior cladding panel system 100 when installed effectively eliminates ‘heating and hording’ during cold weather installs. The EPS exterior cladding panel system 100 comprises less than 10 mm of drainage in preferred embodiments. The panelized EPS stucco siding system 100 comprises (lightweight) cladding. The at least one pre-finished panel assembly 110 is able to be lifted and installed by two individuals such that efficiency is realized during the construction process and for ease in shipping, unloading and installing.

A method of use for installation of the present invention, according to an embodiment of the present disclosure. In particular, the method of use (installation) may include one or more components or features of the EPS exterior cladding panel system 100 as described above. As illustrated, the method of use may include the steps of: step one, providing at least one pre-finished panel assembly, each at least one pre-finished panel assembly including a body having a front-face comprising an exterior-finish-surface; a rear-face; and a thickness; and an insulating means; step two, installing the EPS exterior cladding panel system which provides exterior protection for the host-building and insulation for the host-building; the insulation being thermal-insulation and acoustic-insulation; wherein the step of installing may be accomplished via adhesive and alternately mountable tracks with brackets.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for insulating, protecting and installing are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An EPS exterior cladding panel system comprising:
at least one pre-finished panel assembly, each said at least one pre-finished panel assembly including;
a body having;
a front-face comprising an exterior-finish-surface;
a rear-face; and
a thickness; and
an insulating means; and
wherein said panelized EPS stucco siding system comprises a plurality of said at least one pre-finished panel assembly installed in modular-functional combination;
wherein said body is defined by said front-face, said rear-face separated by said thickness, said rear-face mounted adjacent a host-building in-use; and
wherein said insulating means is integrated into said thickness of each said body such that when in installed-combination said EPS exterior cladding panel system provides exterior protection for said host-building and insulation for said host-building.

2. The EPS exterior cladding panel system of claim 1, wherein said insulating means comprises thermal-insulation.

3. The EPS exterior cladding panel system of claim 1, wherein said insulating means comprises acoustic-insulation.

4. The EPS exterior cladding panel system of claim 1, wherein said at least one pre-finished panel assembly is able to be installed in modular combination with aesthetic reveal.

5. The EPS exterior cladding panel system of claim 1, wherein said at least one pre-finished panel assembly is able to be installed in modular combination without aesthetic reveal to give continuous surface.

6. The EPS exterior cladding panel system of claim 1, wherein the exterior-finish-surface comprises reinforced fiber glass mesh with basecoat.

7. The EPS exterior cladding panel system of claim 6, wherein the exterior-finish-surface comprising said reinforced fiber glass mesh with said basecoat also comprises acrylic finish color.

8. The EPS exterior cladding panel system of claim 6, wherein the exterior-finish-surface comprising said reinforced fiber glass mesh with said basecoat also comprises exterior paint.

9. The EPS exterior cladding panel system of claim 1, wherein the plurality of said at least one pre-finished panel assembly are installed in said modular-functional combination via adhesive to said host-building.

10. The EPS exterior cladding panel system of claim 1, wherein the plurality of said at least one pre-finished panel assembly are installed in said modular-functional combination via mountable tracks coupled to said host-building.

11. The EPS exterior cladding panel system of claim 10, wherein the mountable tracks further comprise brackets.

12. The EPS exterior cladding panel system of claim 1, wherein said insulating means comprises an R value depending on project-application.

13. The EPS exterior cladding panel system of claim 1, wherein the EPS exterior cladding panel system when installed eliminates heating and hording during cold weather installs.

14. The EPS exterior cladding panel system of claim 1, wherein the EPS exterior cladding panel system comprises less than 10 mm of drainage.

15. The EPS exterior cladding panel system of claim 1, wherein the panelized EPS stucco siding system comprises cladding.

16. The EPS exterior cladding panel system of claim 1, wherein the at least one pre-finished panel assembly is able to be lifted and installed by two individuals.

17. An EPS exterior cladding panel system comprising:
at least one pre-finished panel assembly, each said at least one pre-finished panel assembly including;
a body having;
a front-face comprising an exterior-finish-surface;
a rear-face; and
a thickness; and
an insulating means; and
wherein said panelized EPS stucco siding system comprises a plurality of said at least one pre-finished panel assembly installed in modular-functional combination;
wherein said body is defined by said front-face, said rear-face separated by said thickness, said rear-face mounted adjacent a host-building in-use;
wherein said insulating means comprises thermal-insulation and acoustic-insulation;
wherein said at least one pre-finished panel assembly is able to be installed in modular combination with aesthetic reveal and alternately without aesthetic reveal to give continuous surface;
wherein the exterior-finish-surface comprises reinforced fiber glass mesh with basecoat with said basecoat also comprises acrylic finish color and alternately exterior paint;
wherein the plurality of said at least one pre-finished panel assembly are installed in said modular-functional combination via adhesive to said host-building and alternately via mountable tracks coupled to a host-building; and
wherein said insulating means is integrated into said thickness of each said body such that when in installed-combination said EPS exterior cladding panel system provides exterior protection for said host-building and insulation for said host-building.

18. The EPS exterior cladding panel system of claim 17, further comprising set of instructions; and
wherein the EPS exterior cladding panel system is arranged as a kit.

19. A method of use for the EPS exterior cladding panel system, the method comprising the steps of:
providing at least one pre-finished panel assembly, each said at least one pre-finished panel assembly including;
a body having;
a front-face comprising an exterior-finish-surface;
a rear-face; and
a thickness; and
an insulating means; and
installing said EPS exterior cladding panel system which provides exterior protection for said host-building and insulation for said host-building, said insulation being thermal-insulation and acoustic-insulation.

20. The method of claim 19, wherein the step of installing is done via adhesive and alternately mountable tracks with brackets.
